(19) United States
(12) Patent Application Publication
(10) Pub. No.: US 2003/0019207 A1
(43) Pub. Date: Jan. 30, 2003

(54) Wave driven power generation system

(76) Inventor: David Joseph Parker, Bradenton, FL (US)

Correspondence Address: David J. Parker, 4201 18th Ave. West, Bradenton, FL, 34205, US

(21) Appl. No.: 09/924,062

(22) Filed: Jul. 30, 2001

(51) Int. Cl. F16D 31/02

(52) U.S. Cl. 60/398

(57) ABSTRACT

A wave driven power generation system for conversion of energy of ocean waves into electric, hydraulic or pneumatic power using the wave motion and the natural buoyancy of a series of watertight pods driving pistons in hydraulic cylinders, producing pressures and flows suitable for production of electric, hydraulic or pneumatic power. The generation system is suspended in a submerged moored structure enabling maintenance of required elevation with respect to the water surface and alignment of the generation system with the wave fronts.

### BACKGROUND OF INVENTION

1. Field of the Invention

This invention relates to a wave driven power generation system which converts the energy of waves to electric, hydraulic, or pneumatic energy.

2. Brief Description of Prior Art

Wave driven power generation systems which convert the energy of waves to mechanical or electrical energy are generally divided into the air turbine type and the float type. The term “ocean” used herein includes not only oceans but also lakes and other inland bodies of water. In the air turbine type of wave activated power generation system, an air box is anchored so as locate its upper part above the surface of the sea and the lower opening below the surface of the sea so that an air chamber is formed by the box and the sea surface. By repeated vertical displacement of the sea surface in the air chamber caused by ocean waves, the air is alternately expelled from and sucked into the air chamber to generate a flow of air which in turn drives an air turbine connected to an electric power generator. This system is advantageous in that the number of moving parts is relatively small so that the possibility of trouble in operation is relatively small. However, the efficiency of conversion of wave energy into electric energy is relatively low and expensive and large-scale equipment is required.

Another approach is the mounting on shore of a receptacle which converts the energy of incoming waves to a usable kinetic or potential energy form for use in conventional energy conversion systems.

One type of float wave activated power generation system is based on the principle that it is possible to extract wave energy by using a float anchored by a mooring cable. Alternate upward and downward displacement of the sea surface caused by the ocean waves will cause variation in the buoyancy acting on the anchored float. The variation in buoyancy causes variation in the tensile force acting on the mooring cable and is transmitted to a hydraulic piston-cylinder device which pumps fluid to a reservoir. The fluid supplied from the reservoir drives a waterwheel type generator.

When the float is merely anchored through a mooring cable, there is no means for keeping the mooring cable in a tensed condition irrespectively of the level of the surface of the sea. Therefore, when the level of the sea surface lowers with the passing of the trough of a wave, the float does not lower by the full extent of the drop of the sea surface, but, is apt to move horizontally with the waves, so that the amount of the vertical movement of the piston is small as compared with the actual vertical displacement of the sea surface caused by the waves. Energy conversion efficiency for this device is low.

### SUMMARY OF THE INVENTION

It is an object of this invention to provide an improved wave activated power generation system of the float type which is very simple in construction and which has high energy conversion efficiency.

It is also the object of this invention to provide a wave driven power generation system which can be installed in an area independent of depth of water.

According to this invention the float type of wave activated power generation system is based on the principle that it is possible to extract wave energy by using a float fixed to the shaft of a hydraulic cylinder. Alternate upward and downward displacement of the water surface caused by the ocean waves will cause variation in the buoyancy acting on the float. The variation in buoyancy causes variation in the force acting on the cylinder shaft and is transmitted to a hydraulic piston-cylinder device which pumps fluid to a reservoir. The fluid supplied from the reservoir drives a hydraulic motor which, in turn, drives a generator.

According to this invention, there is provided a wave driven power generation system of the float type which comprises at least one piston-cylinder means having a cylinder and a piston slidable in the cylinder and cooperating with the cylinder to form a chamber above the piston, the cylinder having an intake port and an outlet port both formed at an upper portion thereof to communicate with the chamber and each provided with a check valve means. A float means is connected through a shaft to the piston of the piston-cylinder means. A first fluid storage means is connected to the inlet port of the chamber for supplying the chamber with a fluid under a first pressure and a second fluid storage means is connected to the outlet port of the chamber to receive the fluid supplied from the first chamber. The second fluid storage means is adapted to cause a second pressure higher than the first pressure to act on the check valve of the outlet port of the chamber. A hydraulic motor driving an electric generator is connected at its inlet to the second fluid storage means and at its outlet to the first fluid storage means so that the generator is driven by the fluid flowing from the second fluid storage means to the first fluid storage means.

The above and other objects, features and advantages of this invention will become apparent from the following descriptions with reference of preferred embodiments to the accompanying drawings in which the same items are given the same reference numerals through all of the drawings.

### BRIEF DESCRIPTION OF DRAWINGS

FIG. 1 is a side elevation view of a wave driven power generation system, a portion of which is shown schematically.

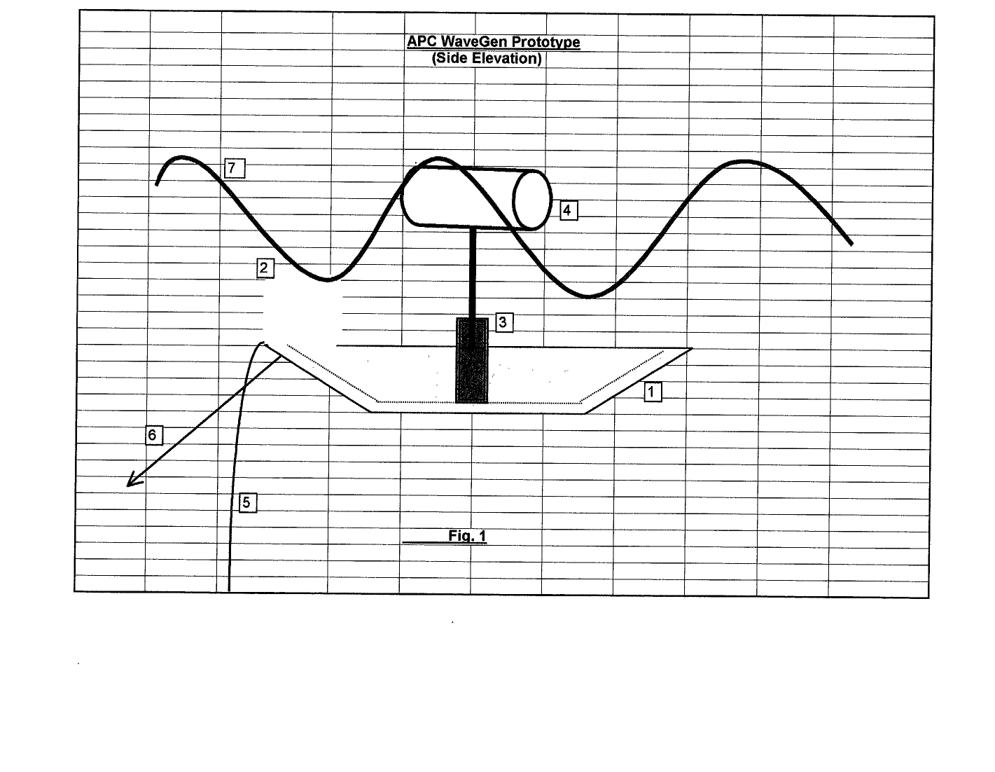

FIG. 2 is a front elevation view of a wave driven power generation system, a portion of which is shown schematically.

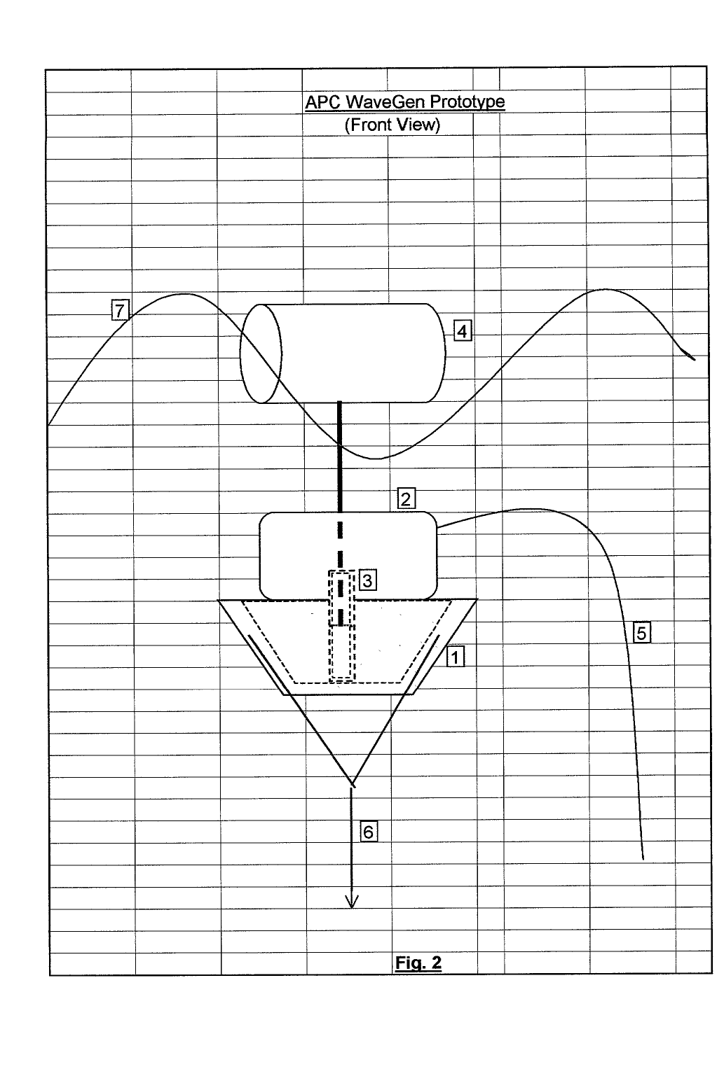

FIG. 3 is a schematic of the hydraulic circuit of the wave driven power generation system.

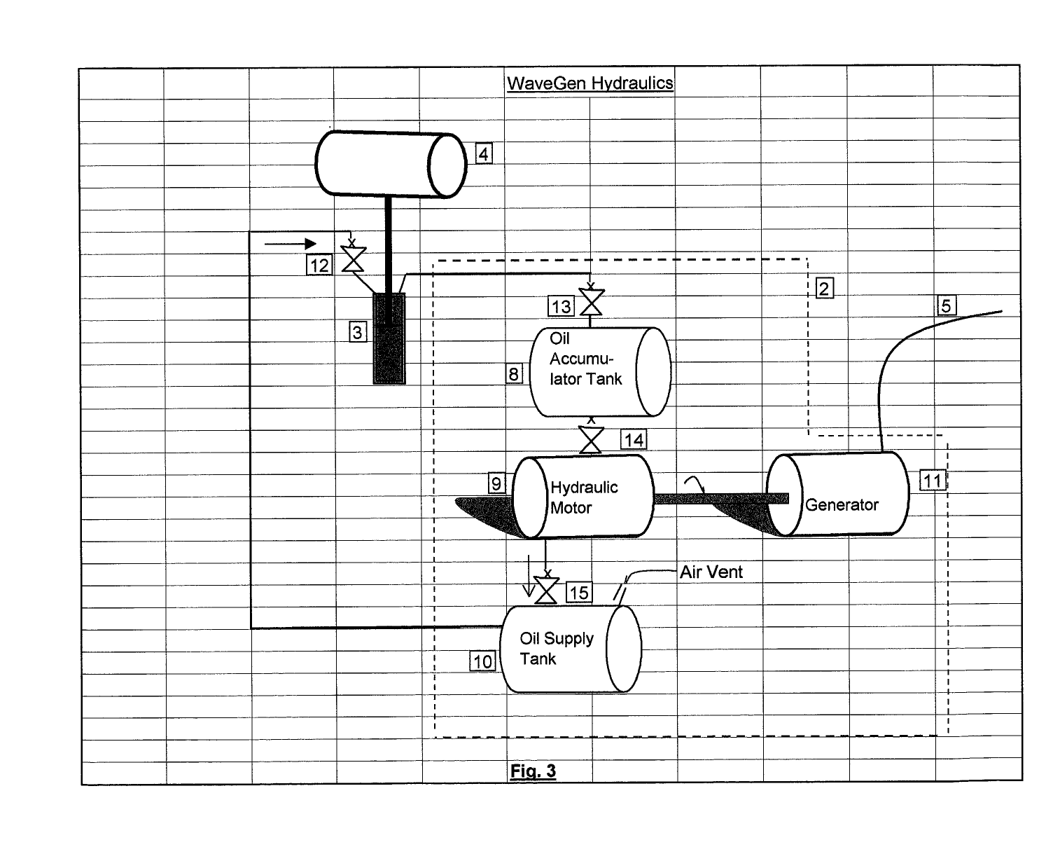

### DESCRIPTION OF THE PREFERRED EMBODIMENT

Referring now to the drawings by numerals of references, there is shown a wave driven power generation system submerged platform 1.

The platform 1 has the form of an open upright boat complete with a portion of the conventional ballast system allowing the platform to be maintained at the correct water depth. Mounted on the platform 1 are the watertight housing 2 and the hydraulic cylinders 3 with the platform 1 anchored to the ocean floor by anchor line 6.

Contained in the watertight housing 2 is the remainder of the conventional ballast system, the oil accumulator tank 8, the oil supply tank 10, the hydraulic motor 9, the electric generator 11, a portion of the power and control cable 5 to shore, and miscellaneous equipment.

Mounted on the floor of the platform 1 are a plurality of hydraulic cylinders 3 arranged in an assembly of rows and columns with each connected/driven by one or more watertight pods 4. The pods 4 are formed from heavy material in a manner to provide the buoyancy to extend the piston under pressure and the weight to return the piston after extension when the pod 4 is located at the trough of the wave 7.

Control valves 12, 13, 14, 15, and electrical switch gear and controls are miscellaneous equipment.

The invention has thus been shown and described with reference to specific embodiments. However, it should be noted that the invention is in no way limited to the details of the illustrated structures but changes and modifications may be made without departing from the scope of the appended claims.

I claim:

1. A wave driven floating power generation system mounted in a submerged moored platform supporting a watertight housing and one or several hydraulic cylinders and pistons slidable in said cylinders each powered by the vertical displacement of a floating pod and cooperating with said cylinder to form a chamber above said piston said cylinders each having an inlet port and an outlet port both formed at an upper portion thereof to communicate with said chamber and each provided with a check valve means; first fluid storage means connected to said inlet port of said chamber for supplying said chamber with a fluid under a first pressure due to the downward displacement of the piston; second fluid storage means connected to said outlet port of said chamber for receiving the said fluid from said chamber under a second pressure caused by the upward displacement of the said piston due to the vertical upward displacement of the said pod caused by wave action; a hydraulic motor having an inlet connected to said second storage means and an outlet connected to the said first storage means; a generator driven by said hydraulic motor means.

2. A wave driven power generation system in accordance with claim 1 wherein said first fluid storage means is a first reservoir located at any elevation within the said watertight housing and said second fluid storage means is a second reservoir similarly located.

3. A wave driven power generation system in accordance with claim 1 wherein said first fluid storage is vented to atmosphere within the waterproof housing

4. A wave driven power generation system in accordance with claim 1 wherein said second fluid storage means is a high pressure tank or accumulator pressurized by the upward displacement of the pistons.

5. A wave driven power generation system in accordance with claim 1 wherein said motor and generator are located in a floating watertight housing.

6. A wave driven power generation system in accordance with claim 1 wherein a number of said piston-cylinder means are associated with one or more said motor(s), said inlet of said motor(s) being connected to the outlet port of each piston-cylinder means.

7. A wave driven power generation system in accordance with claim 1 wherein said floats includes a hollow float member connected to the piston shaft of said piston-cylinder means.

8. A wave driven power generation system in accordance with claim 1 moored by one or more restraint cables but free of vertical cable restraint.

9. A wave driven power generation system in accordance with claim 1 in which the power generated is transported to land by electrical cable or other means.

10. A wave driven power generation system in accordance with claim 1 with submerged support platform upon which is mounted the hydraulic cylinder(s), watertight housing, and other equipment.

11. A wave driven power generation system in accordance with claim 1 in which the support plafform contains ballast necessary to counteract buoyancy and upward motion due to piston thrust.

12. A wave driven power generation system in accordance with claim 11 in which releasing the ballast permits the support platform rising to the water surface for maintenance without unmooring.

13. A wave driven power generation system in accordance with claim 11 where the submerged platform has the form of an upright open boat allowing the weight of the platform and the contained water to provide the restraint necessary to counteract the upward thrust of the said pods.

14. A wave driven power generation system in accordance with claim 12 and 13 which permits location of the submerged platform at a fixed depth relative to the surface.
